(19) United States
(12) Patent Application Publication
(10) Pub. No.: US 2026/0226972 A1
(43) Pub. Date: Aug. 6, 2026

(54) REPLACABLE TOOTH SPROCKET

(71) Applicant: MHJ USA, LLC, Fremont, OH (US)

(72) Inventor: Christopher JAMES, Fremont, OH (US)

(73) Assignee: MHJ USA, LLC, Fremont, OH (US)

(21) Appl. No.: 19/042,456

(22) Filed: Jan. 31, 2025

(51) Int. Cl. F16H 55/12; F16H 55/30

(52) U.S. Cl. CPC F16H 55/12; F16H 55/30

(57) ABSTRACT

A sprocket assembly comprising replaceable outer tooth segments configured for attachment to an inner hub assembly. The inner hub assembly is securable to an input shaft of a machine. Each outer tooth segment is securely fastened to the inner hub via high-strength Huck fasteners. This segmented tooth design allows for selective replacement of worn or damaged teeth without requiring replacement of the entire sprocket assembly.

This application relates to a sprocket assembly for heavy machinery. In an exemplary embodiment, the sprocket is utilized for driving chains. Specifically, the sprocket assembly forms an inner hub section which attaches to the driven shaft with segmented outer teeth sections which drive the chain.

Heavy machinery sprockets typically become worn and require replacement and/or repair. These sprockets typically require significant time and resources to replace. Specifically, the sprockets of certain equipment, such as trenching, screening and milling equipment, are difficult to replace due to the location of the sprockets. A replaceable tooth sprocket (RTS) is provided to alleviate the time and resources required for maintaining the aforementioned equipment. The purpose of the RTS is to provide a modular sprocket that includes teeth segments that are replaceable. Typically, a traditional sprocket is cut in two halves to be installed over the driven shaft. To replace this traditional sprocket, the chain assembly needs to be removed and/or major components of the drive assembly to gain access to the sprockets for replacement. The replacement of a traditional sprocket means replacing the whole sprocket (or half) including the center hub section which wears at a fraction of how fast the sprocket teeth wear. Traditional sprockets require disassembly of equipment in order for maintenance to be performed on the sprocket.

Unlike traditional sprockets that require full replacement, the RTS allows for the replacement of only worn tooth segments while retaining the inner hub. This modular design also increases manufacturing efficiency. The smaller, segmented components minimize material waste during production, as they may be arranged to utilize material space more effectively than larger, traditional sprocket designs.

### SUMMARY

The embodiments disclosed herein relate to a replaceable tooth sprocket (RTS) that reduce the cost and time of maintenance of machinery that utilize sprockets. The RTS includes removable tooth segments, a dovetail mechanism to hold the tooth segments while withstanding torque, and a unique fastening mechanism to secure the tooth sections.

According to one embodiment, a sprocket assembly is disclosed. The sprocket assembly comprising an inner hub having a shaft opening, wherein the inner hub includes hub dovetails extending radially outwards. Outer tooth segments mounted on and surrounding the inner hub, wherein the plurality of outer tooth segments includes outer dovetails extending radially inwards, and wherein each outer tooth segment are directly adjacent with another outer tooth segment. The hub dovetails and the outer dovetails have an interlocking configuration such that the outer tooth segments lock to the hub dovetails of the inner hub both radially and circumferentially.

According to another embodiment, a sprocket assembly is disclosed. The sprocket assembly comprising an inner hub having a shaft opening, wherein the inner hub includes hub dovetails extending radially outwards. Outer tooth segments mounted on and surrounding the inner hub, wherein the plurality of outer tooth segments includes outer dovetails extending radially inwards and are configured to be installed in an axial direction relative to the inner hub. The hub dovetails and the outer dovetails have an interlocking configuration. Fasteners configured to extend through the inner hub and outer tooth segments, wherein the fasteners are fastened to only carry loads parallel to the axial direction.

According to another embodiment, a sprocket assembly is disclosed. The sprocket assembly comprising an inner hub having a shaft opening, wherein the inner hub includes hub dovetails extending radially outwards. Outer tooth segments mounted on and surrounding the inner hub, said outer tooth segments includes outer dovetails extending radially inwards wherein the outer dovetails are configured to lock radially with the hub dovetails. Said outer tooth segments include webs, wherein the outer dovetails and the webs define recesses that correspond to the shape of the hub dovetails. Fasteners configured to extend through each hub dovetail and each webs of the outer tooth segments, wherein said fasteners compress the inner hub and outer tooth segments together.

### BRIEF DESCRIPTION OF THE DRAWINGS

FIG. 1 shows an exemplary RTS from a front isometric view.

FIG. 2 shows an exemplary RTS from a rear isometric view shown in FIG. 1.

FIG. 3 shows the exemplary RTS shown in FIG. 1 shown in disassembled form.

FIG. 4 shows an inner hub of the exemplary RTS shown in FIG. 1.

FIG. 5 shows outer tooth segments of the exemplary RTS shown in FIG. 1

FIG. 6 shows steps for assembling the exemplary RTS shown in FIG. 1.

FIG. 7 shows steps for assembling the exemplary RTS shown in FIG. 1.

FIG. 8 shows steps for assembling the exemplary RTS shown in FIG. 1.

FIG. 9 shows a machining pattern of traditional sprocket.

FIG. 10 shows a machining pattern of the exemplary RTS shown in FIG. 1.

FIG. 11 shows a machining pattern of the outer tooth segments.

FIG. 12 shows a close up of a portion of the inner hub and outer tooth.

FIG. 13 shows another embodiment of an exemplary RTS from the front.

FIG. 14 is a perspective view of an outer tooth segment of the exemplary RTS as shown in FIG. 13.

FIG. 15 is a facing view of an outer tooth segment of the exemplary RTS as shown in FIG. 13.

FIG. 16 is a rear view of the RTS embodiment shown in FIG. 13.

### DETAILED DESCRIPTION

The particulars shown herein are by way of example and for purposes of illustrative discussion of the disclosed embodiments and are presented to provide a readily understood description of the principles and conceptual aspects. In this regard, no attempt is made to show structural details in more detail than is necessary for a fundamental understanding, and the description taken together with the drawings make apparent to those skilled in the art how the disclosed devices and methods may be embodied in practice.

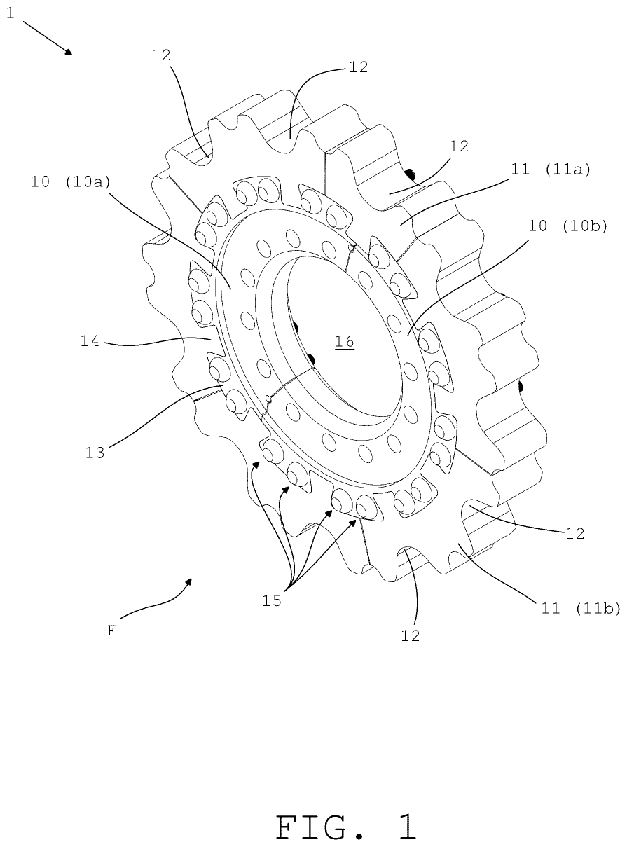

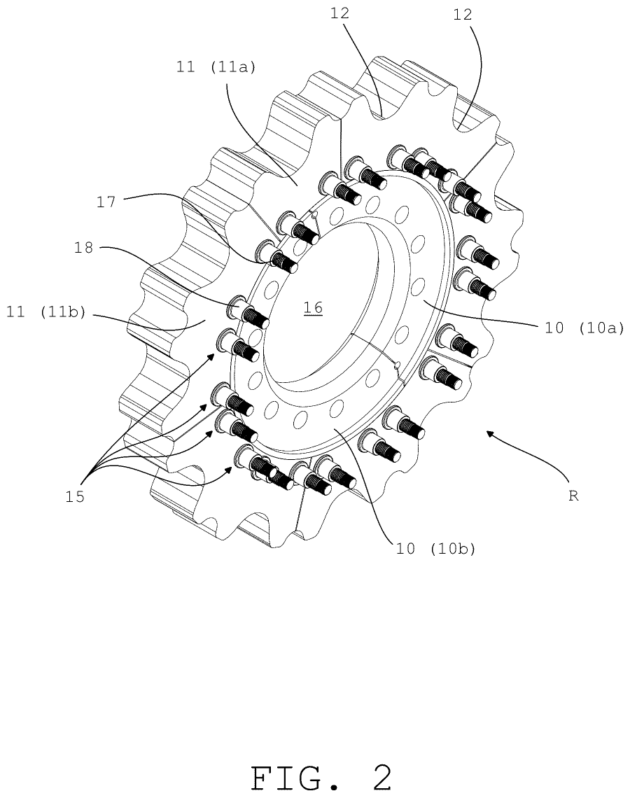

FIG. 1 and FIG. 2 shows an exemplary replaceable tooth sprocket (RTS) 1 having a front side ‘F’ and a rear side ‘R’. The RTS 1 includes an inner hub 10 having two (or more) inner hub sections 10a and 10b. The hub is surrounded by outer tooth segments 11. The sprocket arrangement shown in FIG. 1 is an exemplary embodiment showing a combination of a single outer tooth segment 11a and a double outer tooth segment 11b is shown. The RTS 1 may also be reversible so that opposite sides of the tooth face (i.e., the sides that contact and impart force to the outer component such as a chain) may wear evenly and allows the RTS to be utilized on opposing sides of a machine or equipment. The outer tooth segments 11 of the RTS may be formed using entirely single outer tooth segments 11a or of entirely of double outer tooth segments 11b or of a combination of both single and double outer tooth segment 11a, 11b. The number of teeth (single, double, triple, etc.) per tooth segment 11 is dependent on the machinery utilizing the sprocket. A single outer tooth segment 11a may only include a single teeth space 12, while a double outer tooth segment may include two tooth spaces. In a confined or tighter area of a machine, the sprocket may include only of single outer tooth segments to facilitate ease of access and replacement of the outer tooth segments 11 given a limited amount of space. Machinery with more space may be able accommodate an RTS that utilizes a greater number of teeth per tooth segment (e.g., a double outer tooth 11b). The RTS includes an opening 16 configured to accommodate the insertion of the sprocket to a drive shaft.

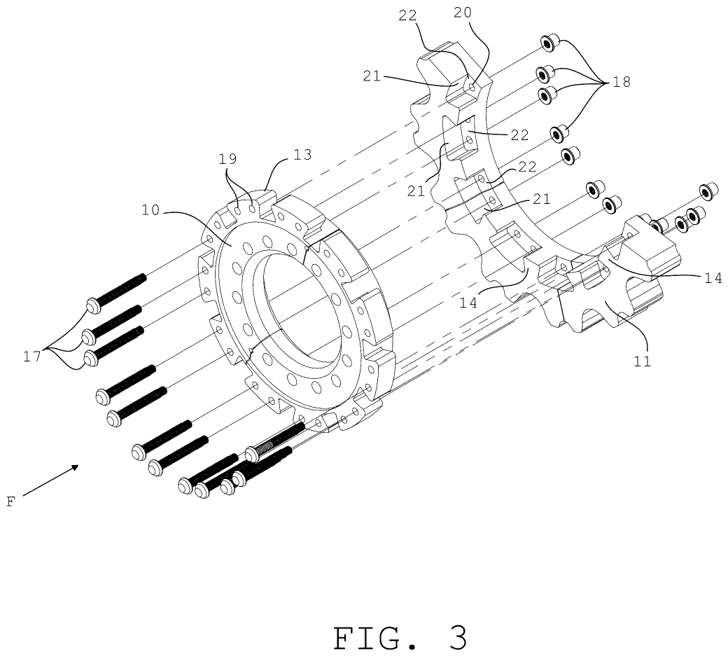

FIG. 3 shows a partial exploded view of the RTS 1. An upper portion of the outer tooth segments 11 have been omitted for clarity. The inner hub 10 includes one or more hub dovetails 13 configured to mate with corresponding outer tooth dovetails 14 on each outer tooth segment 11. This interlocking dovetail configuration provides a secure attachment between the outer tooth segments 11 and the inner hub 10, enabling the assembly to withstand torque applied to the teeth of the tooth segments. The RTS 1 may also include huck fasteners 15 that is configured to fasten the outer tooth segments 11 to the inner hub 10 via hub fastening holes 19 and tooth fastening holes 20. Each huck fastener includes a huck pin 17 and a huck collar 18. The huck collar 18 is swaged onto the huck pin 17 via a huck fastening tool (e.g., a huck gun). The collar is smooth (unthreaded) on the inside and, unlike a nut. The huck fastening tool pulls the huck pin's pintail at the end of the pin threads in order pull the gun onto the collar, where the collar is drawn into the recess in the nose of the huck fastening tool, causing it to be pressed firmly into the threads of the pin and swage tightly around the pin threads to create a semi-permanent connection. Due to the semi-permanent nature of the connection, the collars need to be cut to be unfastened. The threads of the huck pin have a unique geometry compared to a standard pin or bolt. Unlike conventional pins or bolts, huck pins 15 feature threaded grooves that mechanically lock the collar 18 in place. This secure, permanent installation, as opposed to traditional pins or nut-and-bolt assemblies, provides huck pins with significantly higher fatigue strength and resistance to vibrational loosening.

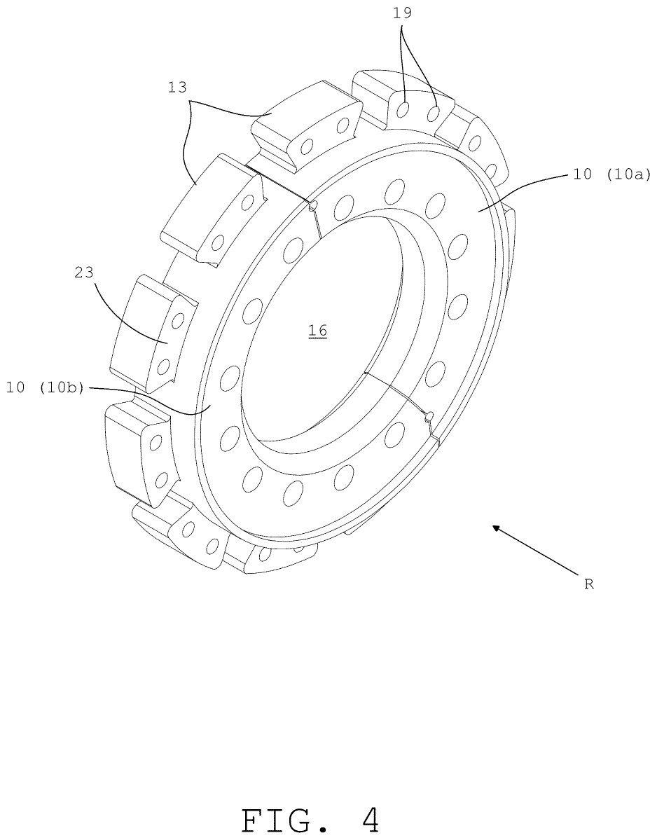

The outer tooth segments 11 may include a recess 21 corresponding to the shape of the inner hub dovetail 13. The recesses 21 may be arranged on the outer tooth segments 11 such that two recesses 21 from separate and distinct tooth segments 11 create a joint recess to accommodate the shape of the hub dovetail 13. The outer tooth segments 11 includes a web 22 configured to face towards the hub 10 and the corresponding hub dovetail 13. As seen in FIG. 4, the rear face 23 of each hub dovetails 13 is configured to contact and interface with a corresponding web 22. The hub dovetails 13 are configured to sit within corresponding recess 21.

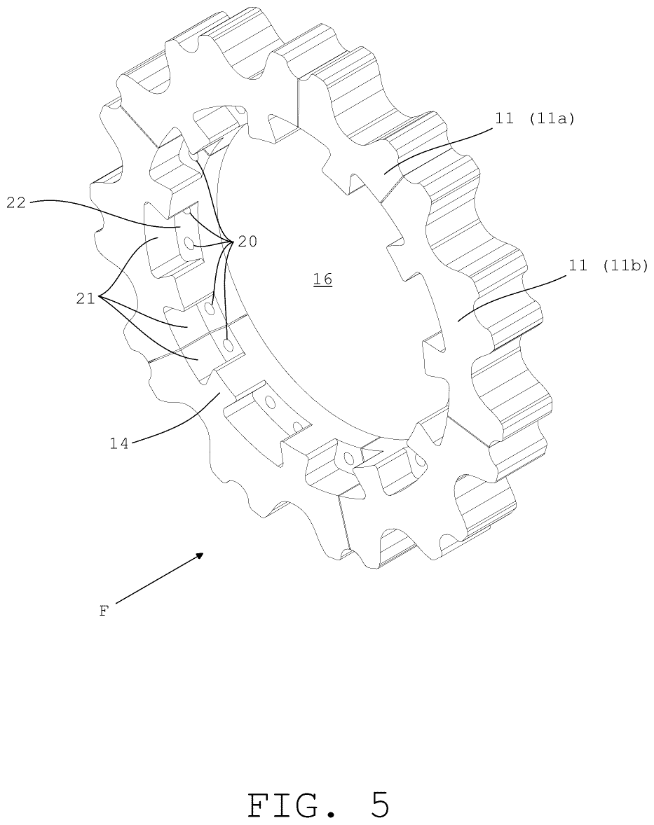

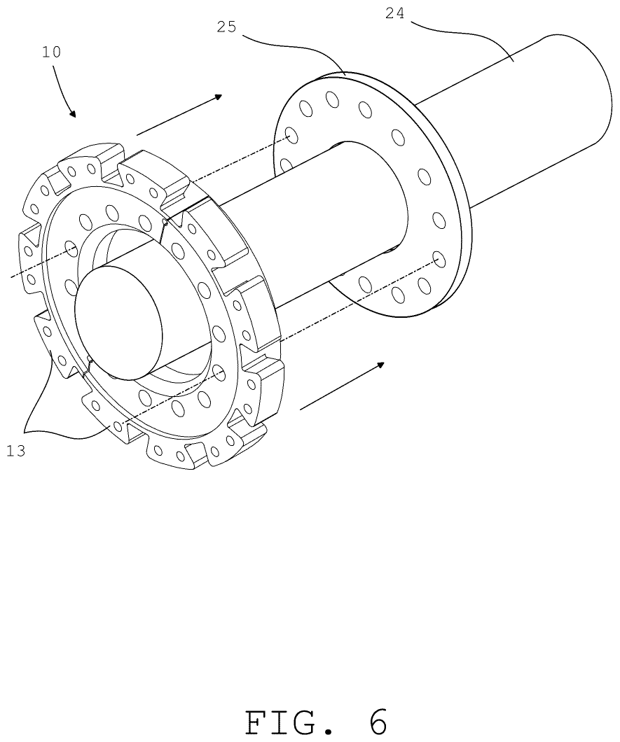

FIG. 5 shows the exemplary full assembly of the outer tooth segment 11. The huck pin 17 extends through the hub dovetail 13 via hub fastening holes 19 and through the outer tooth segments 11 via tooth fastening holes 20. The huck collars 18 are fastened adjacent the rear side ‘R’ of the outer tooth segments. The huck fasteners 15 clamp the outer tooth segments 11 and the inner hub 10 axially. The hub dovetails 13 and outer tooth dovetails 14 are cut and machined with rounded edges to overcome propagation of cracks and prevent concentrated stress points. The strength of the mating of the tooth segments to the inner hub as well as the torque loading is controlled by the dovetail. The dovetail locks the inner hub and the outer tooth segments and eliminates the need for the fasteners (e.g., the huck fasteners 15) to take specific loads. The interlocking dovetail configuration secures the inner hub 10 and outer tooth segments 11 radially and circumferentially, allowing the inner hub 10 and outer tooth segments 11 to maintain its interlocking configuration despite rotational forces (e.g., radial and tangential/circumferential forces due to applied torque) imparted from an input shaft (see FIG. 6). This interlocking dovetail connection eliminates the need for fasteners to manage torque loads. Instead, the huck fasteners 15 are only utilized to hold the inner hub 10 and outer tooth segments 15 together and not to take torque load (e.g., radial and tangential/circumferential forces due to applied torque) imparted on the RTS.

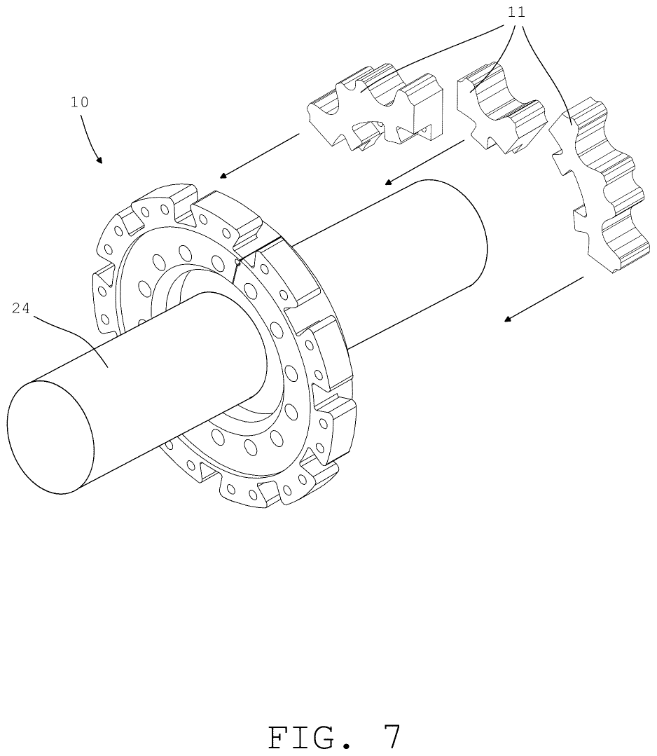

As shown in FIG. 6-8, an exemplary RTS 1 may be assembled onto a drive shaft 24 having a drive shaft hub 25. First, as shown in FIG. 6, the inner hub 10 may include fastening points to attach to the driveshaft hub 25 via fasteners (not shown). Second, as seen in FIG. 7, the outer tooth segments 1 may be inserted from the rear side of the inner hub 10. Third, the huck pins 17 and huck collars 18 are inserted and fastened with the aid of a huck fastening tool.

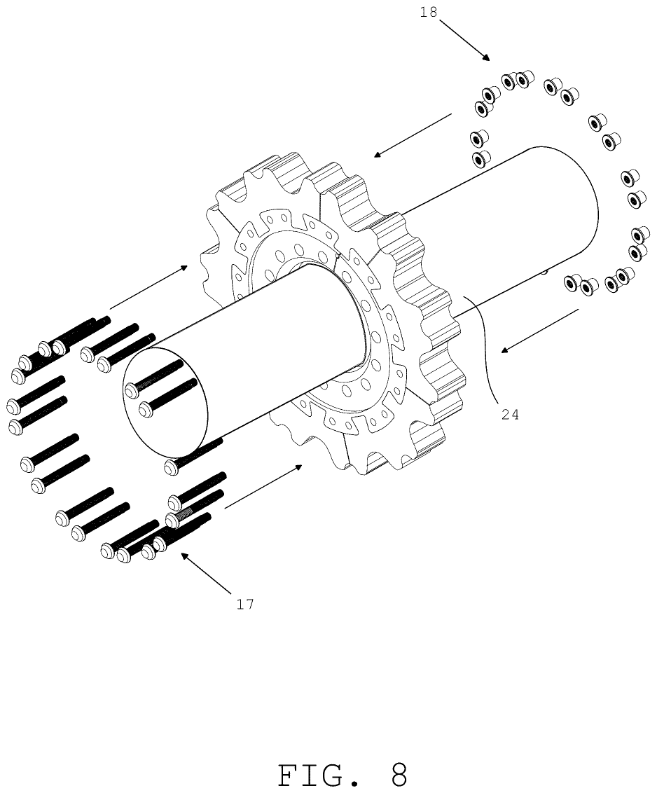

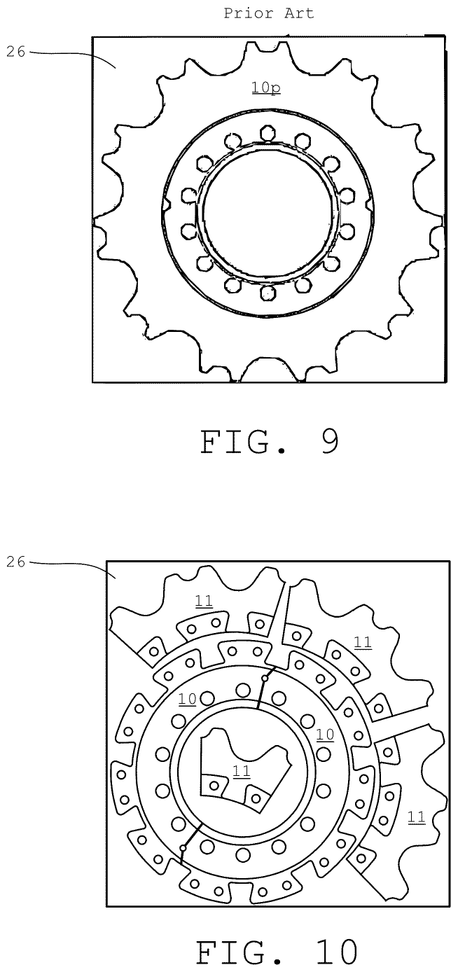

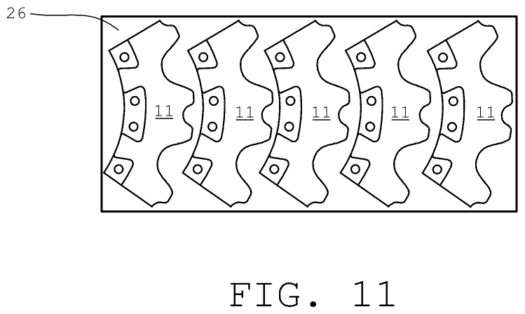

One advantage of the various disclosed embodiments of the RTS, as discussed earlier, is the efficiency in its manufacturing process. The embodiments of the disclosed RTS allow for smaller sections of material to be manufactured, leading to less waste in the production over the production of a traditional sprocket (e.g., sprocket10p), as may be seen in FIG. 9. The method of cutting and machining traditional sprockets may generate up to 40% waste of the starting raw material. As shown in FIG. 10, the tooth sections may be made from the outer edges of the material in addition to the center of the hub. Although only a portion of the needed outer tooth segments 11 to complete the full sprocket is made, additional tooth segments may be made in a separate block of material. As seen in FIG. 11, additional tooth segments may be made in an efficient manner utilizing more material space than the traditional sprocket. This manufacturing process, produces less material waste overall than the traditional sprocket as seen in FIG. 9. The inner hub and tooth segments are either water-jet cut or cut with via electronic discharge machining from a material block 26. The inner hub and outer tooth segments may be machined after cutting depending on the sprocket application.

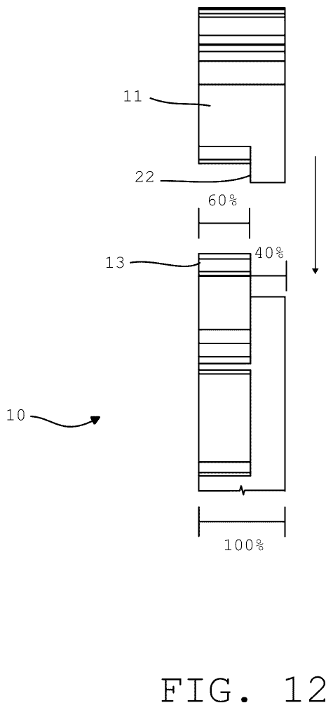

As shown in FIG. 12, according to one embodiment, on one face of the dovetail area of the inner hub, only 40% of material is machined. This area machined to form an overlap or “shiplap” of the outer tooth 11 and inner hub 13 once assembled. This shiplap creates an area of where the huck fasteners is to be inserted and installed.

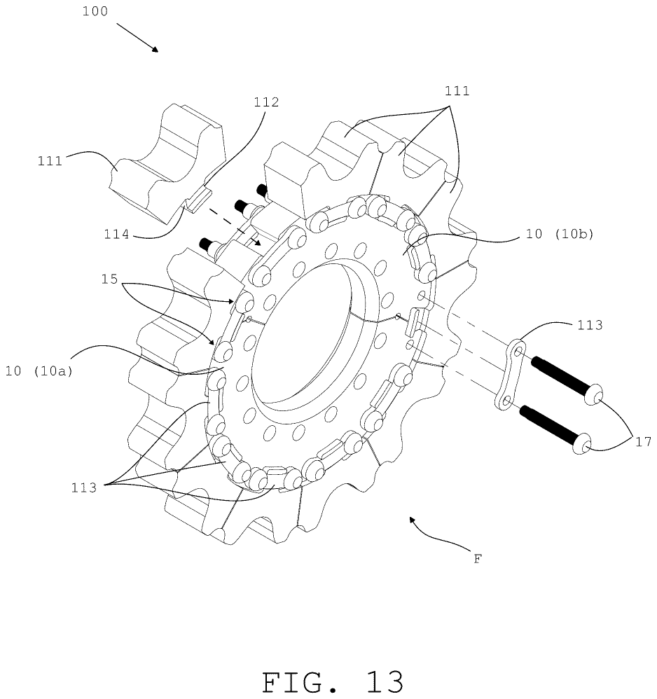

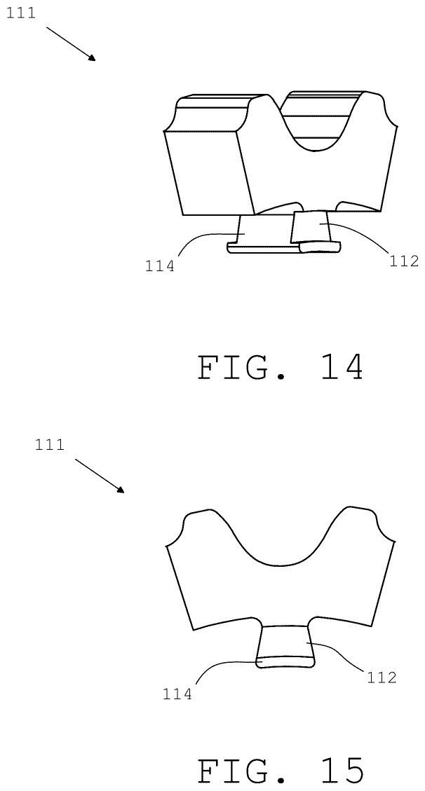

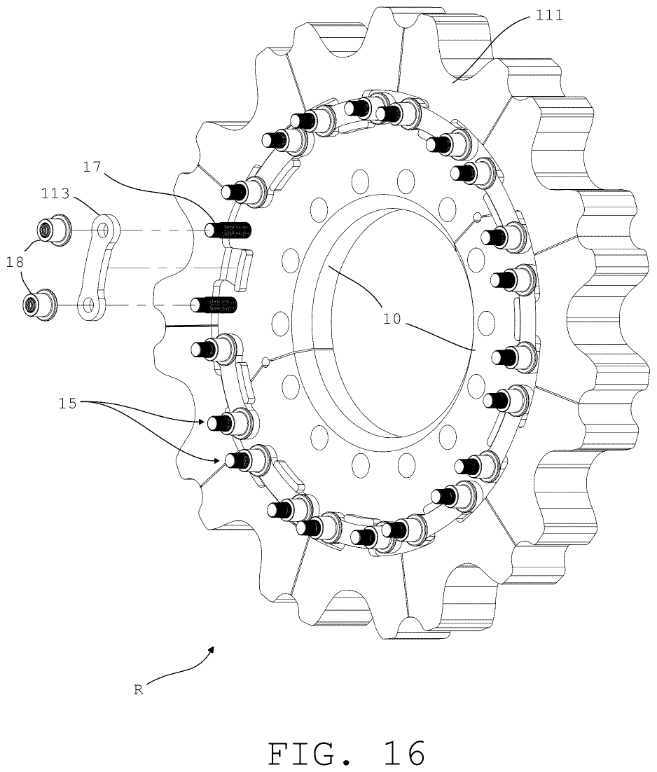

FIG. 13 shows another embodiment of an RTS 100. This embodiment includes similar core components, which comprises the inner hub 10 having two (or more) inner hub sections 10a and 10b, huck pins 17, and huck collars 18. RTS 100 includes an outer teeth segment 111 having a recess 112. The recess 112 are configured to accommodate tooth keepers 113. The outer segments 111 include a dovetail 114. Dovetail 114 functions identically to dovetail 13 described above. The dovetails create a strong, interlocking connection between two pieces of material, to resist forces that would pull them apart. In this case, the dove tails maintain the interlocking connection between the outer tooth segments and the inner hub 10. FIGS. 14 and 15, show detailed views of the outer tooth segment 111. The recess 112 is located on the lower portion of the outer tooth segment 111. The recess 112 is located radially inwards relative to the outer tooth segment engagement surface, adjacent to the dovetail 114. The recess 112 may be located at the middle of the tooth segment 111.

As seen in FIGS. 13 and 16, the tooth keepers 113 are held on recess 112 by huck fasteners 15 both on the front side ‘F’ and rear side ‘R’. This configuration prevents the tooth segments 111 from sliding forwards or rearwards relative to the inner hub 10. Tooth keepers 113 may be accommodated within the recess 112 of the outer tooth segments such that the tooth keepers 113 are configured to be flush to the face of the tooth segment 111 both on the front side ‘F’ and/or read side ‘R’.

According to one embodiment, the RTS may be made of steel. In one embodiment, the RTS may be made of Toolox® 44. The use of this type of steel may prolong tooth life as well as maintain the integrity of the dovetail on the inner hub, leading to a longer life of the hub section as well. The RTS may also be treated with plasma nitride.

According to one embodiment, each of the inner hub dovetails 13 may be the same size and shape. According to another embodiment, each of the outer tooth segment dovetails 14 may be the same size and shape. According to another embodiment, both the inner hub dovetails 13 and the outer tooth segment dovetails 14 may be the same size and shape. According to another embodiment, the size and shape of the inner hub dovetails 13 is different from the size and shape of the outer tooth segment dovetails 14. According to one embodiment, the inner hub dovetails 13 may be spaced evenly around the inner hub 10. According to one embodiment, the outer segment dovetails 14 may be spaced evenly around the complete circumference of the inner hub.

According to one embodiment, the spacing between the outer tooth segments 11 is reduced so that outer tooth segments 11 are substantially adjacent to one another without the inner hub separating the main bodies of the outer tooth segments.

The foregoing examples have been provided merely for the purpose of explanation and are in no way to be construed as limiting of implementations of the present invention. While aspects of the present invention have been described with reference to exemplary embodiments, it is understood that the words which have been used herein are words of description and illustration, rather than words of limitation. Changes may be made, within the purview of the appended claims, as presently stated and as amended, without departing from the scope and spirit of the present disclosure in its aspects. Although implementations of the present invention have been described herein with reference to particular means, materials and embodiments, implementations disclosed herein are not intended to be limited to the particulars disclosed herein; rather, implementations of the present invention extend to all functionally equivalent structures, methods and uses, such as are within the scope of the appended claims.

1. A sprocket assembly comprising:
an inner hub having a shaft opening, wherein the inner hub includes hub dovetails extending radially outwards;
outer tooth segments mounted on and surrounding the inner hub, wherein the plurality of outer tooth segments includes outer dovetails extending radially inwards, and wherein each outer tooth segment is directly adjacent with another outer tooth segment; and
wherein the hub dovetails and the outer dovetails have an interlocking configuration such that the outer tooth segments lock to the hub dovetails of the inner hub both radially and circumferentially.

2. The assembly of claim 1, further comprising a fastener extending through the hub dovetails and the outer tooth segments.

3. The assembly of claim 2, wherein the fastener is a huck fastener having a huck pin and a huck collage swaged onto the huck pin, wherein the huck fastener is configured to compress the inner hub and the outer tooth segments.

4. The assembly of claim 2, wherein the fastener are fastened to only carry loads in an axial direction parallel to the pin body.

5. The assembly of claim 1, wherein the inner hub is comprised of segments.

6. The assembly of claim 1, wherein the hub dovetails of the same shape and size.

7. The assembly of claim 1, wherein the outer tooth segments axially movable relative to the inner hub.

8. The assembly of claim 1, further comprising a tooth keeper for each outer tooth segment the plurality of outer tooth segments;
wherein each outer tooth segment includes a recess for accommodating the tooth keeper to prevent the corresponding tooth keeper from moving axially relative to the inner hub;

9. A sprocket assembly comprising:
an inner hub having a shaft opening, wherein the inner hub includes hub dovetails extending radially outwards;
outer tooth segments mounted on and surrounding the inner hub, wherein the plurality of outer tooth segments includes outer dovetails extending radially inwards and are configured to be installed in an axial direction relative to the inner hub;
wherein the hub dovetails and the outer dovetails have an interlocking configuration; and
fasteners configured to extend through the inner hub and outer tooth segments, wherein the fasteners are fastened to only carry loads parallel to the axial direction.

10. The assembly of claim 9, wherein the fasteners are configured to extend through each hub dovetail.

11. The assembly of claim 10, wherein the fastener is a huck fastener having a huck pin and a huck collage swaged onto the huck pin, wherein the huck fastener is configured to compress the inner hub and the outer tooth segments.

12. The assembly of claim 9, wherein the inner hub is comprised of segments.

13. The assembly of claim 9, wherein the hub dovetails of the same shape and size.

14. The assembly of claim 9, wherein the outer tooth segments axially movable relative to the inner hub.

15. A sprocket assembly comprising:
an inner hub having a shaft opening, wherein the inner hub includes hub dovetails extending radially outwards;
outer tooth segments mounted on and surrounding the inner hub, said outer tooth segments includes outer dovetails extending radially inwards wherein the outer dovetails are configured to lock radially with the hub dovetails;
said outer tooth segments include webs, wherein the outer dovetails and the webs define recesses that correspond to the shape of the hub dovetails; and
fasteners configured to extend through each hub dove tail and each webs of the outer tooth segments, wherein said fasteners compress the inner hub and outer tooth segments together.

16. The assembly of claim 14, wherein the fastener is a huck fastener having a huck pin and a huck collage swaged onto the huck pin, wherein the huck fastener is configured to compress the inner hub and the outer tooth segments.

17. The assembly of claim 14, wherein the inner hub is comprised of segments.

18. The assembly of claim 14, wherein the hub dovetails of the same shape and size.

19. The assembly of claim 14, wherein the outer tooth segments axially movable relative to the inner hub.

20. The assembly of claim 14, wherein the fasteners are fastened to only resist loads in an axial direction parallel to the pin body.
